(19) United States
(12) Patent Application Publication
(10) Pub. No.: US 2012/0303384 A1
(43) Pub. Date: Nov. 29, 2012

(54) TREATMENT PLAN CREATION WORKFLOW TRACKING

(75) Inventors: Christopher Stepaniak, Western Springs, IL (US); Lina Arbash Meinel, Homewood, IL (US); Hania Abdulraouf Al-Hallaq, Chicago, IL (US)

(73) Assignee: KONINKLIJKE PHILIPS ELECTRONICS N.V., EINDHOVEN (NL)

(21) Appl. No.: 13/575,311

(22) PCT Filed: Jan. 7, 2011
(86) PCT No.: PCT/IB2011/050070

§ 371 Date: Jul. 26, 2012

Related U.S. Application Data
(60) Provisional application No. 61/301,671, filed on Feb. 5, 2010.

(51) Int. Cl. G06Q 50/22

(52) U.S. Cl. 705/2

(57) ABSTRACT

A method for tracking creation of a treatment plan for a patient includes obtaining an input indicative of a state of a task in the treatment plan creation workflow and generating a signal indicative of a set of tasks of the treatment plan creation workflow, including the state of the task corresponding to the received input. A system includes a processor (100) that generates a treatment plan for a patient based on a treatment plan creation workflow for the patient, wherein the treatment plan creation work-flow includes one or more tasks to be completed for generating the treatment plan and an apparatus (112, 116 and/or 118) that presents a signal indicative of a state of at least one of the treatment plan or the one or more tasks.

The following generally relates to tracking treatment plan creation workflow and is described with particular application to therapy treatment.

The creation of a radiation therapy treatment plan for a patient generally involves several actors (e.g., physicians, therapists, medical physicists, medical dosimetrists, etc.) working with various systems and serving different roles. Examples of such systems include, but are not limited to, a hospital information system (HIS), a picture archiving and communication systems (PACS) system, a treatment planning (TP) system, a record and verify (R & V) system, etc. Communication of information between these systems facilitates efficient and timely completion of the treatment plan, which can be a labor intensive task, often consuming one or more weeks. Unfortunately, these systems generally are separate and distinct systems, not well suited for sharing information.

One approach for aggregating the information from these systems has been to have the various actors manually record their information on a common substrate such as a physical whiteboard or the like hanging in a physic's or other department. Unfortunately, manual recordation of the information by an actor is subject to human error. In addition, overall treatment planning efficiency may be reduced by the time between obtaining the information and recording the information on the whiteboard and/or the time between the recording of the information and the viewing of the recorded information by an actor who will perform a next step. Furthermore, no permanent record of the treatment plan creation workflow is kept (i.e., the whiteboard is erased). Moreover, the workflow information may only be in one location (e.g., on a single white board) or different portions of the workflow are distributed across multiple locations (e.g., different portions are on different whiteboards in different locations).

With facilities that do not have electronic patient records, physical file folders have also been used. Such folders have included all of the planning information and patient records. A patient's file folder usually has to move around from department to department for a couple of weeks while the information used for treatment planning is entered and/or updated. Unfortunately, moving a file folder around as such may increase the probability of misplacing or losing the folder, decrease efficiency, and/or result in compromising patient privacy. One trend has been to attach a wireless tracking device on the folder to mitigate misplacing and losing the folder. However, tracking devices are not fool proof, and the folder is still moved around from department to department, creating inefficiencies.

Aspects of the present application address the above-referenced matters and others.

According to one aspect, a method for tracking creation of a treatment plan for a patient includes obtaining an input indicative of a state of a task in the treatment plan creation workflow and generating a signal indicative of a set of tasks of the treatment plan creation workflow, including the state of the task corresponding to the received input.

According to another aspect, a system includes a processor that generates a treatment plan for a patient based on a treatment plan creation workflow for the patient, wherein the treatment plan creation workflow includes one or more tasks to be completed for generating the treatment plan and an apparatus that presents a signal indicative of a state of at least one of the treatment plan or the one or more tasks.

According to another aspect, a computer readable storage medium encoded with instructions which, when executed by a computer, cause a processor of the computer to perform the step of: tracking creation of a treatment plan, including dynamically presenting and updating states of tasks of a treatment plan creation workflow used to create the treatment plan.

The invention may take form in various components and arrangements of components, and in various steps and arrangements of steps. The drawings are only for purposes of illustrating the preferred embodiments and are not to be construed as limiting the invention.

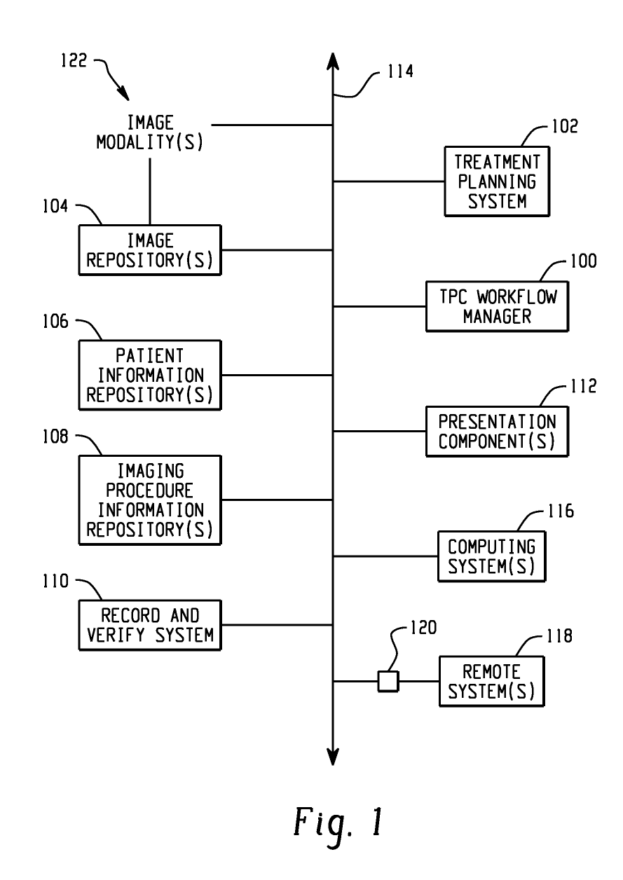

FIG. 1 illustrates an example treatment system.

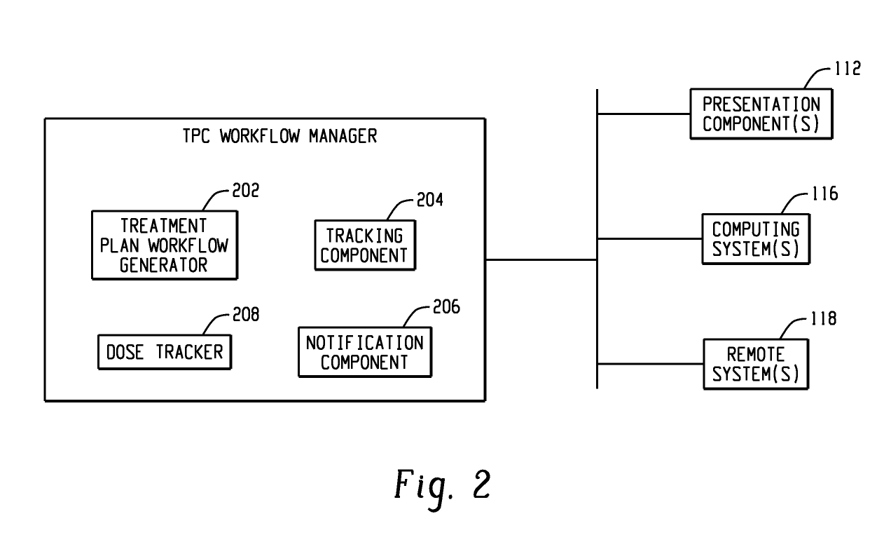

FIG. 2 illustrates an example treatment workflow manager.

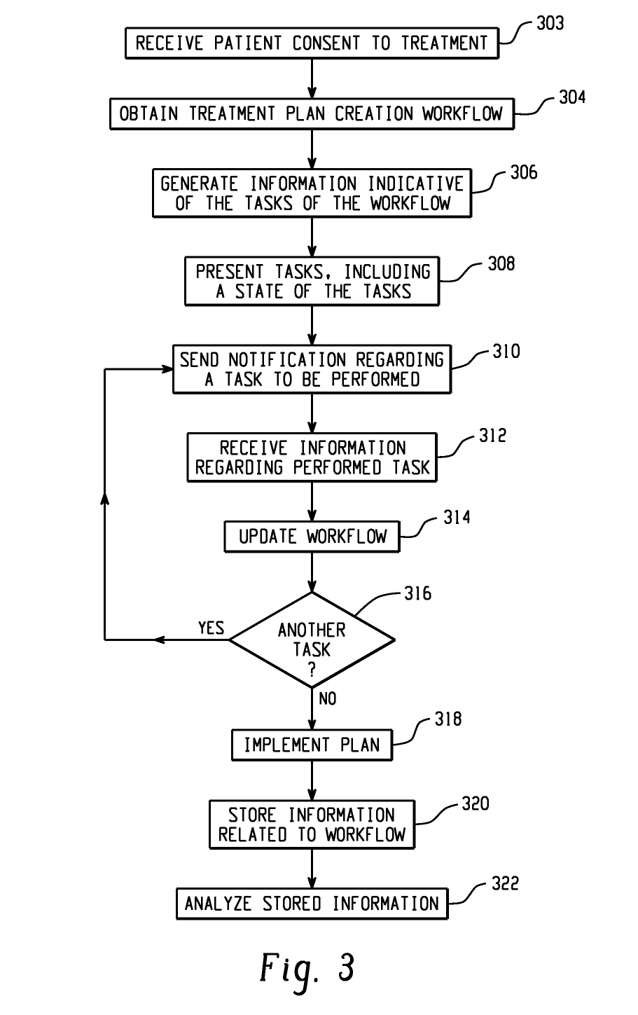

FIG. 3 illustrates an example method.

The following generally relates to tracking treatment plan creation in connection with treatment such as radiation therapy, chemotherapy, particle (e.g., proton) therapy, high intensity focused ultrasound (HIFU), ablation, surgery, a combination thereof and/or other treatment for a patient. As described in greater detail below, in one instance this includes integrating various systems used to generate treatment plans and dynamically tracking treatment planning progress and/or coordinating completion of treatment planning tasks from, for example, simulation through the start of treatment. This may improve treatment planning efficiency as well as other aspects of creating a treatment plan.

Initially referring to FIG. 1, an example system for generating treatment plans is illustrated. As shown, in this embodiment, the system is comprised of a plurality of different systems used to perform different functions in connection with creating treatment plans. The different systems are described next.

A treatment plan creation (TPC) workflow manager 100 manages creation of treatment plans. In one instance, and as described in greater detail below, this may include obtaining, generating, modifying, deleting, etc. a set of tasks to be performed to create a treatment plan, identifying a state of the tasks (e.g., completed, being completed, to be completed, etc.), presenting the tasks in a human readable format, including the state of the tasks, dynamically updating the presented tasks, including the presented state of the tasks, notifying authorized personnel that a task is to be performed, etc.

The illustrated treatment plan creation workflow manager 100 can communicate with the various different systems to at least obtain the state information from the systems. The illustrated treatment plan creation workflow manager 100 can additionally or alternatively communicate with one or more systems to obtain other information such as, but not limited to, imaging data and/or non-imaging data. Examples of non-imaging data, includes, but is not limited to, pathology, molecular, laboratory, insurance, genetic, billing, family history, etc. information.

A treatment planning system 102 is used to generate a treatment plan for the patient. In the illustrated embodiment, treatment plans are generated based at least in part on imaging data such as images from the one or more image repositories 104. For example, images from the repositories 104 can be used to identify regions of interest through segmentation, contouring, or the like. Other treatment plans may not utilize images from the repositories 104. A non-limiting example of an image repository 104 includes a picture archiving and communication systems (PACS) repository or the like.

The treatment plan creation workflow manager 100 and/or the treatment planning system 102 can obtain patient information from the one or more of the patient information repositories 106, which may include a hospital information system (HIS) or the like. Imaging information about previous imaging procedures for the patient can be obtained from the one or more of the imaging procedure information repositories 108, which may include a radiology information system (RIS) or the like.

A record and verify system 110 records treatment parameters and/or is used to verify a performed treatment is performed in accordance with the recorded treatment parameters. The record and verify system 110 may also be configured to communicate with systems in radiology departments, admitting departments, billing departments, insurance facilities, etc.

One or more presentation components 112 are used to visually and/or audibly present information indicative of the tasks and/or the state of the tasks for creating the treatment plan. For example, in one instance one of the one or more presentation components 114 includes one or more displays variously located to visually present the tasks and/or the state of the tasks. Additionally or alternatively, such information can be provided audibly.

In the illustrated embodiment, one or more of the actors 100-110 communicate over a bus or local area network 114. Such communication may include wire and/or wireless communication. In another embodiment, at least two of the systems additionally or alternatively communicate via a different communication channel or protocol. By way of example, images can be conveyed from an image repository 104 to the treatment planning system 102 via the Digital Imaging and Communications in Medicine (DICOM) protocol and/or other protocol.

One or more of the actors 100-118 can also communicate with one or more other actors such as a computing system in a laboratory department, an admitting department, a billing department, an insurance department, pathology department, a radiology department, a surgery department, an oncology department, etc. As such, information such as pathology, molecular diagnostics, bloodwork, insurance plan, billing records, etc. in addition or alternative to imaging data can be employed by and/or communicated via the actors 100-118.

One or more computing systems 116 (e.g., a computer, an imaging system workstation, etc.) can be used to view the information provided by the treatment plan creation workflow manager 100. Such viewing can be done through a web based application or other portal executing on a computing system 116. A non-limiting web based application may include one or more web pages. For example, with one non-limiting embodiment, there may be separate web page for patient data, treatment workflow, treatment workflow progression, physics, etc. A navigation bar or the like may be provided for navigation between the various web pages. In one instance, such web pages are automatically populated as information becomes available. In addition, a plan may only be populated when predetermined or all of the steps necessary for performing a task have been completed. Non-web based interfaces are also contemplated herein. Access to such information can be limited to authorized personnel via a log on and password and/or the like.

One or more remote systems 118 include apparatuses such as cell phones, smartphones, pagers, electronic data assistants, e-mail, etc. carried by personnel, set-top boxes connected to a display, a television, etc., computers, and/or other apparatuses. The illustrated one or more remote systems 118 communicate at least with the treatment plan creation workflow manager 100 through an interface 120 to the local area network 114. Such communication includes communication of the treatment plan creation tasks, the state of the tasks, notifications regarding tasks to be performed, operator notes and comments, etc. As with the computing systems 116, such communication can be through web and/or non-web based interfaces, include security (e.g., log on, password, etc.), etc.

One or more imaging modalities 122 can be used to generate the images in the image repositories 104. Examples of suitable imaging modalities include, but are not limited to, computed tomography (CT), magnetic resonance (MR), positron emission tomography (PET), single photon emission tomography (SPECT), ultrasound (US), radiography (X-ray), mammography, positron emission mammography (PEM), digital tomosynthesis, and/or other modalities and/or any combinations of the modalities such as MRI/US, PET/CT, . . . etc. As shown, at least one of the one or more imaging modalities 122 can communicate directly with an actor (e.g., the image repository(s) 104) and/or over the network 114.

Integrating the different components of the treatment system and/or other systems via the network 114 and/or the treatment plan creation workflow manager 100 may facilitate shortening treatment planning time and mitigating human error and thus improving efficiency and quality, relative to a configuration in which the treatment plan creation workflow manager 100 is omitted. In addition, sharing treatment planning information (such as three-dimensional dose distributions or other information) with departments such as a radiology department and/or other department may facilitate present and/or future diagnosing of patients who have been previously treated, including improving the accuracy of the diagnosis.

It is to be appreciated that one or more of the actors 100-110 can be implemented via one or more processors executing one or more computer executable instructions embedded on one or more local and/or remote computer readable mediums.

FIG. 2 illustrates an example treatment plan creation workflow manager 100.

A treatment plan workflow generator 202 generates workflows (e.g., of tasks) for creating treatment plans for patients. A particular generated workflow may be based on various factors such as a type of treatment (e.g., radiation, chemo, surgery, etc.), patient demographics, patient medical history, previously created and/or implemented treatment plans, a default workflow, an operator created workflow, etc. The workflow can be modified and/or updated, for example, by a received input (e.g., from a user and/or a device). In one example, a change may be made to the workflow based a result of completing a task, a change a status of the patient, an availability of a resource used to perform a task, workflow commentary in the literature, etc. In one instance, generation of a workflow for a patient occurs upon an indication that the patient has consented and/or is approved for the treatment.

A tracking component 204 tracks the treatment plan creation workflow. This includes tracking a progress of the workflow, including changes, completion of tasks, tasks to be completed, etc. The tracking component 204 provides this information for presentation, for example, via the presentation components 112, the computing systems 116, the remote systems 118, and/or other systems.

A notification component 206 sends notification indicating various information such as the tasks for creating a treatment plan, a state of the various tasks, an indication of the addition and/or deletion of a task, an alert or warning regarding a task, an indication that a task is ready to be performed, and/or other information. The notification can be sent via various communication techniques such as via email, a text message, an instant message, a phone call, a page, and/or other electronic communications signal.

The notification may also include an operator note, comment, etc. corresponding to a previously performed and/or subsequent task to be performed. By way of example, when a treatment plan is ready for physician review, a summary note of the key dosimetric features and/or trade-offs for the various plans can be included in a notification sent to the physician or other personnel. The physician can view the note before, during and/or after reviewing the treatment plan, select an appropriate plan for treatment, and, optionally, include a comment, for example, to indicate potential further areas of improvement.

An optional dose tracker 208 generates a signal indicative of the dose delivered and/or a simulated dose delivered to patients. The tracking component 204 can provide the dose information by itself or along with the task information and/or other information. In one instance, this may include a dose-volume histogram and/or other dose based information. The notification component 206 can generate and send notifications based on the dose information. For instance, the notification component 206 can generate and send a notification regarding the dose delivered, for example, as predetermined dose milestones are met, which may be used to alert personnel to begin the next plan, which may facilitate ensuring treatment continuity.

FIG. 3 illustrates a non-limiting method for tracking and/or coordinating creation of a treatment plan. It is to be appreciated that the ordering of the following acts is not limiting. As such, one or more of the acts may occur earlier, later or concurrently with another act. In addition, in other embodiments, more or less, including similar and/or different acts, may be included.

At 302, a patient consents to a treatment.

At 304, the treatment plan creation workflow manager 100 obtains a treatment plan creation workflow for the patient. Patient information from the patient information repositories 106 and/or other repository may be used to obtain information about the patient.

At 306, the treatment plan creation workflow manger 100 generates information indicative of the tasks for creating the treatment plan, including the state of one or more of the tasks and/or other information.

At 308, the treatment plan creation workflow manger 100 presents the tasks, including the state of one or more of the tasks and/or other information. As indicated herein, this information can be viewed by authorized personnel via the one or more presentation components 112, the one or more computing systems 116, the one or more remote systems 118, and/or one or more other apparatuses.

At 310, the treatment plan creation workflow manager 100 notifies an actor of a treatment workflow task to be performed. As discussed herein, the notification can be through the visual and/or audible presentation of information via the one or more presentation components 112, the one or more computing systems 116, the one or more remote systems 118, and/or otherwise. In another embodiment, the actor is otherwise notified.

At 312, once the task is performed, information regarding the task is provided to the treatment plan creation workflow manager 100. Such information can be entered via authorized personnel and/or via conveyance of the information over the network 114. The information may include information related to whether the task was performed as planned, whether the task was changed, a date on which the task was performed, a timestamp indicating a start, end and/or duration, an identification of a person overseeing completion of the task, and/or other information.

At 314, the treatment plan creation workflow is updated. As discussed herein, updating the workflow may include a dynamic update in which the information about the tasks being presented via the one or more presentation components 112, the one or more computing systems 116, the one or more remote systems 118 is updated to reflect the current state of the tasks.

At 316, if another task is to be performed, acts 310-314 are repeated.

At 318, if no other task is to be performed, the treatment plan can be implemented.

At 320, optionally, the treatment plan creation workflow and/or the progress thereof can be stored electronically in a storage repository and made available for retrieval and/or viewing as described herein.

At 322, optionally, retrospective analysis of the treatment plan creation workflow can performed. This may provide information regarding efficiency, differences with other treatment workflow, parameters for subsequent treatment, and/or other information.

The above may be implemented by way of computer readable instructions, which, when executed by a computer processor(s), causes the processor(s) to carry out the acts described herein. In such a case, the instructions are stored in a computer readable storage medium such as memory associated with and/or otherwise accessible to the relevant computer.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for tracking a treatment plan creation workflow for a patient, comprising:
obtaining an input indicative of a state of a task in the treatment plan creation workflow; and
generating, via a processor, a signal indicative of a set of tasks of the treatment plan creation workflow, including the state of the task corresponding to the received input.

2. The method of claim 1, further comprising:
generating the set of tasks in response to an indication that the patient consents to the treatment.

3. The method of claim 1, further comprising:
obtaining information for the treatment plan creation workflow from at least one of a hospital information system or a radiology information system.

4. The method of claim 1, wherein the input is obtained from at least one or more of an image repository, a treatment planning system, or a record and verify system.

5. The method of claim 4, wherein the image repository, the treatment planning system, and the record and verify system transfer data over a same network using a same network protocol.

6. The method of claim 1, further comprising:
generating a notification that indicates at least one of a next task, of the set of tasks, to be performed or an update to the status of a task.

7. The method of claim 6, further comprising:
transmitting the notification to a remote device that displays the notification.

8. The method of claim 7, wherein the remote device includes one or more of a cell phone, a smartphone, a pager, telephone, a set-top box, or an email account.

9. The method of claim 1, further comprising:
presenting the signal in a human readable format.

10. The method of claim 1, further comprising:
presenting the signal via a web-based application.

11. The method of claim 1, further comprising:
generating data indicative of a dose delivered to the patient based on the treatment plan creation workflow; and
presenting the data indicative of the dose delivered to the patient.

12. The method of claim 1, further comprising:
retrospectively analyzing the treatment plan creation workflow.

13. The method of claim 1, wherein the treatment is one of radiation therapy, chemotherapy, particle therapy, high intensity focused ultrasound, ablation, surgery, or a combination thereof.

14. The method of claim 1, further comprising:
at least one of creating a treatment plan based on the treatment plan creation workflow or updating the treatment plan creation workflow based on a received input.

15. The method of claim 14, further comprising:
using information of the treatment plan for at least one of determining a subsequent diagnosis for the patient or determining a diagnosis for a different patient.

16. A system, comprising:
a processor that generates a treatment plan for a patient based on a treatment plan creation workflow for the patient, wherein the treatment plan creation workflow includes one or more tasks to be completed for generating the treatment plan; and
an apparatus that presents a signal indicative of a state of at least one of the treatment plan or the one or more tasks.

17. The system of claim 16, further comprising:
a notification component that sends a notification that indicates a next task of the set of task to be performed.

18. The system of claim 17, wherein the notification component sends the notification to a remote device that displays the notification.

19. The system of claim 16, wherein the processor receives an input indicative of at least one of a state or a change of state of a task of the treatment plan creation workflow from one or more of an image repository, a treatment planning system, or a record and verify system.

20. The system of claim 19, wherein two or more of the processor, the image repository, the treatment planning system, or the record and verify system communicate over a same network.

21. The system of claim 19, wherein the treatment planning system implements at least a portion of a treatment plan created based on the treatment plan creation workflow.

22. The system of claim 19, wherein at least one of the processor, the image repository, the treatment planning system, or the record and verify system communicate over a same network communicates information with one or more of a laboratory department, an admitting department, a billing department, an insurance department, pathology department, a radiology department, a surgery department, or an oncology department.

23. The system of claim 16, wherein the apparatus presents the signal in a human readable format via graphical user interface.

24. The system of claim 16, wherein the processor updates at least one of the treatment plan or the treatment plan creation workflow based on a received input.

25. The system of claim 16, further comprising:
a dose tracker that generates data indicative of a dose delivered to the patient based on tasks of the treatment plan creation workflow.

26. The system of claim 25, wherein the dose information is used for subsequent diagnoses of patients.

27. A computer readable storage medium encoded with instructions which, when executed by a computer, cause a processor of the computer to perform the step of:
tracking creation of a treatment plan, including dynamically presenting and updating states of tasks of a treatment plan creation workflow used to create the treatment plan.
